(19) United States
(12) Patent Application Publication
(10) Pub. No.: US 2021/0197130 A1
(43) Pub. Date: Jul. 1, 2021

(54) FLUOROPOLYMER LATEX COATINGS FOR MEMBRANES

(71) Applicant: Arkema Inc., King of Prussia, PA (US)

(72) Inventor: Walter Philip KOSAR, Pottstown, PA (US)

(21) Appl. No.: 17/055,301

(22) PCT Filed: Jun. 4, 2019
(86) PCT No.: PCT/US2019/035320

§ 371 Date: Nov. 13, 2020

Related U.S. Application Data
(60) Provisional application No. 62/682,190, filed on Jun. 8, 2018.

(51) Int. Cl. B01D 67/00; B01D 65/00; B01D 61/14; B01D 71/34; B01D 69/02; B01D 61/36; C09D 127/16

(52) U.S. Cl. CPC B01D 67/0088; B01D 65/003; B01D 61/145; B01D 61/147; B01D 2325/38; B01D 69/02; B01D 61/364; C09D 127/16; B01D 2323/04; B01D 71/34

(57) ABSTRACT

The invention concerns polymer microfiltration or ultrafiltration porous membranes, intended for the treatment of effluents. More specifically, the invention concerns filtration membranes having at least one surface coated with a fluoropolymer-based latex.

### TECHNICAL FIELD

The present invention relates to polymer filtration membranes, in particular polymer microfiltration or ultrafiltration membranes, intended for the treatment of effluents. More specifically, the invention concerns filtration membranes having at least one surface coated with a fluoropolymer-based latex.

### BACKGROUND

Microfiltration (MF) and ultrafiltration (UF) membranes are frequently used to carry out the purification of effluents, in particular water for the production of drinking water, or the treatment of sewage before it is discharged to the environment.

Porous membranes, generally formed as thin sheets of substantially uniform thickness, have a sponge-like internal structure containing millions of intercommunicating channels, the channels having a substantially uniform width within narrow limits. The membrane pore sizes are generally controlled to be relatively uniform over a very small range. In the case of microfiltration membranes, the pore size ranges generally fall within the general range of from 0.2 to about 10 micrometers. The range of pore sizes for ultrafiltration membranes varies from 0.002 to 0.2 μm.

Porous membranes can been modified (post membrane formation) to improve specific properties. U.S. Pat. No. 6,734,386 describes post-treatment of PVDF membranes by polymerizing acrylic monomers on the surface of the membrane. Post-treatment reactions are complex and add costly steps to the manufacturing process.

Many types of membranes from microporous water filtration membranes to dense film gas separation membranes make use of an external coating. In gas separation and desalination membranes, coatings, such as silicones, are well known to be used to help seal defects in the cast membranes. Sealing the defects improves separation. In porous microfiltration and ultrafiltration, coatings have been used for a variety of benefits including altering hydrophilicity/hydrophobicity, adding a fouling resistant layer, and reducing the pore size to increase rejection. An example of this last point include membranes described in document US 2010000937, in which a microporous TIPS (thermally induced phase separation) membrane is converted into an ultrafiltration membrane by surface coating with a polymer solution containing a fluorine resin polymer and cellulose ester.

Many coatings are applied by a reactive grafting process. These become chemically bonded to the membrane structure. Usually reactive monomers are polymerized to create the coating. These reactive coatings require some type of curing process, either thermal, UV, or high energy radiation such as plasma treatment. In these cases, it is necessary to remove all traces of the starting monomers once the coating has been cured in separate washing step. Post treatments such as these add substantial manufacturing cost to the membranes, which is detrimental in price sensitive markets such as water filtration. Another drawback with many of these coatings is that they do not hold up to aggressive cleaning and chlorine treatments often used in water treatment systems. They may have good initial performance, but as the coating is degraded, the performance benefit is degraded as well.

There is still a need to provide further filtration membranes which are modified by a simpler approach in order to improve specific properties, without the disadvantages listed above.

This aim is achieved by the use of a fluoropolymer latex or fluoropolymer-acrylic latex (commonly referred to as “acrylic modified fluoropolymer” or AMF latex) to coat the surface of membranes, partly or totally.

### SUMMARY OF THE INVENTION

It is a first object of the invention to provide a coated porous filtration membrane, wherein at least one surface of the membrane is coated with a fluoropolymer-based emulsion.

According to one embodiment, the fluoropolymer-based emulsion contains at least one polyvinylidene fluoride (PVDF) polymer or copolymer.

According to another embodiment, the fluoropolymer-based emulsion is a fluoropolymer-acrylic latex.

Another object of the invention is a process for manufacturing said coated membrane, comprising the steps of:

i. providing a porous filtration membrane;
ii. providing a fluoropolymer-based emulsion;
iii. immersing said membrane in said emulsion for a period sufficient to allow the membrane to become wet, followed by air drying of the wet membrane, and
iv. heat drying the membrane to remove residual water.

The present invention also encompasses the use of the coated filtration porous membrane thus prepared for water purification, purification of biological fluids, wastewater treatment, osmotic distillation, and process fluid filtration.

The present invention makes it possible to overcome the disadvantages of the state of the art. It more particularly provides porous filtration membranes modified by means of fluoropolymer-based latex coatings, which are environmentally friendly and do not require high energy curing steps. Many coatings can be formed by air drying at ambient temperatures. The ease of application also allows multiple coating steps or use of multiple coating types to optimize the surface treatment. A variety of polymer chemistries can be manufactured in latex emulsion. This offers a range of possible functionality of the final coating, and hence provides various applications for the coated membranes.

### BRIEF DESCRIPTION OF THE DRAWINGS

FIG. 1 is a diagram displaying the pore size distribution versus micrometers, for a surface-treated membrane versus an untreated membrane.

FIGS. 2 and 3 are images of said membranes when examined under an optical microscope (60×): FIG. 2 corresponds to a PVDF membrane surface, latex treated, whereas FIG. 3 corresponds to a PVDF membrane surface with no latex treatment.

### DESCRIPTION OF EMBODIMENTS

The invention will now be described in more detail without limitation in the following description.

Fluoropolymer based emulsion products are used in manufacturing high performance coatings. These coatings are water based and can be dried under mild conditions. These coatings have outstanding weatherability, UV resistance, and resistance to oxidants. They have been successfully applied to a number of substrates such as metal, ceramic tile, plastic film, and vinyl siding. The present invention is based on the use of these types of emulsions for coating membranes to improve performance properties such as rejection and fouling resistance.

It is a first object of the invention to provide a coated porous filtration membrane, wherein at least one surface of the membrane is coated with a fluoropolymer-based emulsion.

### Membrane Fluoropolymer-Based Coating

The fluoropolymer coating for the membrane is an aqueous-based coating. The coating may be, for example, a fluoropolymer latex, a blend of a fluoropolymer latex and one or more compatible polymer latexes, or an acrylic modified fluoropolymer latex.

The preferred fluoropolymer is polyvinylidene fluoride, which may be one or more homopolymers made by polymerizing vinylidene fluoride (VDF), and copolymers, terpolymers and higher polymers of vinylidene fluoride wherein the vinylidene fluoride units comprise greater than 70 percent of the total weight of all the monomer units in the polymer, and more preferably, comprise greater than 75 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Preferred copolymers or terpolymers are formed with vinyl fluoride, trifluoroethene, tetrafluoroethene (TFE), and hexafluoropropene (HFP).

Preferred copolymers are of VDF comprising from about 71 to about 99 weight percent VDF, and correspondingly from about 1 to about 29 percent TFE; from about 71 to 99 weight percent VDF, and correspondingly from about 1 to 29 percent HFP (such as disclosed in U.S. Pat. No. 3,178,399); and from about 71 to 99 weight percent VDF, and correspondingly from about 1 to 29 weight percent trifluoroethylene.

Preferred terpolymers are the terpolymer of VDF, HFP and TFE, and the terpolymer of VDF, trifluoroethene, and TFE, The especially preferred terpolymers have at least 71 weight percent VDF, and the other comonomers may be present in varying portions, but together they comprise up to 29 weight percent of the terpolymer.

The polyvinylidene fluoride could also be a functionalized PVDF, produced by either copolymerization or by post-polymerization functionalization. Additionally the PVDF could be a graft copolymer, such as, for example, a radiation-grafted maleic anhydride copolymer.

The PVDF used in the invention is generally prepared by means known in the art, using aqueous free-radical emulsion polymerization—although suspension, solution and supercritical CO2 polymerization processes may also be used. In a general emulsion polymerization process, a reactor is charged with deionized water, water-soluble surfactant capable of emulsifying the reactant mass during polymerization and optional paraffin wax antifoulant and catalyst. The mixture is stirred and deoxygenated. A predetermined amount of chain transfer agent, CTA, is then introduced into the reactor, the reactor temperature raised to the desired level and vinylidene fluoride (and possibly one or more comonomers) are fed into the reactor. Once the initial charge of vinylidene fluoride is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably the PVDF emulsion of the invention is fluorosurfactant free, with no fluorosurfactants being used in any part of the polymerization.

In one embodiment, the aqueous fluoropolymer coating composition of the invention may also be a blend of one of more fluoropolymers with one or more compatible polymers, such as an acrylic latex.

The acrylic polymer may be present at from 1 to 40 parts, and more preferably 5 to 30 parts to 60 to 99, and more preferably 70 to 95 parts by weight of fluoropolymer solids. The acrylic latex and fluoropolymer latex may be formed by blending one into the other.

“Acrylic polymers”, as used herein is meant to include polymers, copolymers and terpolymers formed from alkyl methacrylate and alkyl acrylate monomers, and mixtures thereof. The term “(meth)acrylate” is used herein to indicate either acrylate, methacrylate, or a mixture thereof. The alkyl methacrylate monomer is preferably methyl methacrylate, which may make up from 50 to 100 percent of the monomer mixture. 0 to 50 percent of other acrylate and methacrylate monomers or other ethylenically unsaturated monomers, included but not limited to, styrene, alpha methyl styrene, acrylonitrile, and crosslinkers at low levels may also be present in the monomer mixture. Other methacrylate and acrylate monomers useful in the monomer mixture include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. Alkyl (meth) acrylic acids such as methyl acrylic acid and acrylic acid can be useful for the monomer mixture. Preferably, the acrylic polymer is a random copolymer containing 70 to 99, and more preferably 90-99 weight percent of methyl methacrylate units, and from 1 to 30, and more preferably 1 to 10 weight percent of one or more C1-4 alkyl acrylate units. In particular, a specific useful terpolymer is one containing about 95.5-98.5 weight percent of methylmethacrylate units, 1-3 weight percent (meth)acrylic acid units and 0.5-1.5 weight percent of ethyl acrylate units.

In another preferred embodiment, small amounts of from 0.5 to 10, and preferably from 1 to 5 weight percent of (meth)acrylic acid are used as comonomers with methylmethacrylate. The copolymer formed contains enhanced hydrophilicity due to the presence of the acid functionality.

In another embodiment, the acrylic polymer is a block co-polymer which may be a di- or tri-block copolymer.

According to another embodiment of the invention, the fluoropolymer coating may be an acrylic modified fluoropolymer hybrid. The acrylic fluoropolymer hybrid is formed by a latex emulsion process, using a fluoropolymer as a seed, and subsequently polymerizing one or more (meth)acrylic monomers, including (meth)acrylic acid monomers, in the presence of the fluoropolymer seeds. This forms a complex hybrid structure, which may be in the form of an interpenetrating polymer network (IPN), where the fluoropolymer and hydroxyl-functional acrylic polymer are intimately physically intertwined, or may have a core-shell of raspberry structure. Formation of these hybrid polymers is described in U.S. Pat. No. 6,680,357 and US 2011/0118403, incorporated herein by reference.

AMF dispersions are formed by swelling a fluoropolymer seed dispersion with one or more acrylic monomers and then polymerizing the acrylic monomers. The AMF dispersions can be of one or more different types, including in the form of an interpenetrating network dispersion in water (for one type of acrylic monomer or acrylic monomers miscible with the fluoropolymer seed), or in the form of a hybrid structure where two or more different acrylic monomers are used—in which one of more are immiscible with the fluoropolymer seed—resulting in a partial interpenetrating network, with associated polymer phases.

In one embodiment of the invention, a high melting point fluoropolymer seed is used (melting point >125° C., preferably >140° C. and most preferably >150° C.), along with a non-functional acrylic polymer which is miscible with the fluoropolymer component. Examples of such miscible acrylic polymer compositions are given in the patents and applications incorporated by reference. In this embodiment, the morphology of the AMF dispersion particles may be either of the “core-shell” or “IPN” type. In practice, IPN type dispersions based on PVDF homopolymers or copolymers may be defined as those which have a first heat DSC enthalpy of melting of less than about 20 Joules/gram on dry polymer. If dispersions of the core-shell type are used in the invention, it is necessary to heat the coating at some point in the fabrication process (when drying the coating, or subsequently during a lamination or heat treatment step) to a temperature which is at least within 10° C. of the crystalline melting point of the fluoropolymer component (or higher), in order to achieve an intimate mixture of the fluoropolymer and acrylic components. If dispersions of the IPN type are used, it is not necessary to heat the composition at any point above the minimum film formation temperature of the dispersion, i.e. that minimum temperature which is required to form the aqueous composition into a continuous dry film.

A second embodiment is an AMF formed from a PVDF copolymer seed having little or no crystallinity (defined as a crystalline melting point of <125° C. and a total crystallinity as measured by differential scanning calorimetry of less than 20 J/g), along with a thermodynamically miscible acrylic component. In this case the material would be likely to have an IPN type morphology, and it is not necessary to heat the composition at any point above the minimum film formation temperature of the dispersion, i.e. that minimum temperature which is required to form the aqueous composition into a continuous dry film. In this second preferred AMF embodiment, the IPN may be internally cross-linked by means of using a reactive monomer incorporated in the IPN or, an added reactive co-resin that can be internally cross-linked may be used, to enhance the thermal resistance. The reactive components in such cases are not designed to react with the substrate. Generally the ratio of fluoropolymer seed to the acrylic monomers is in the range of 10-90 parts by weight of fluoropolymer to 90-10 parts by weight of the acrylic, preferably 50-80 parts by weight of fluoropolymer to 50-20 parts by weight of the acrylic. A further embodiment is a fluoropolymer/acrylic hybrid in which two or more different vinyl monomer compositions are sequentially polymerized in the presence of the fluoropolymer seed, as described in WO 2010/005756.

The fluoropolymer composition may contain 2 to 33% of a low molecular weight cross-linker that cross-links the fluoropolymer formulation to improve heat resistance. The addition of the cross-linking improves thermal stability resistance of the coating, hardness and scratch resistance and even solvent resistance. In one preferred embodiment, the fluoropolymer composition contains no cross-linking agents.

### Membrane Material

In one embodiment, the porous filtration membranes used in the present invention are polymeric materials chosen among: cellulose esters such as cellulose acetate, polyimides, polyamides, polycarbonates, polysulfone, polyethersulfone, polyacrylonitrile, polyethylene, polypropylene, polyether ether ketone, polyether ketone, fluoropolymers (polyvinylidene fluoride, polytetrafluoroethylene) and combinations thereof.

In another embodiment, the porous filtration membranes used in the present invention are made of inorganic materials such as ceramic.

In a preferred embodiment, the porous filtration membranes used in the present invention are made of polyvinylidene fluoride (PVDF) polymer or copolymer.

In one embodiment, the porous filtration membranes used in the present invention are made from a blend of PVDF or PVDF copolymers with one or more compatible acrylic polymers. In general, the PVDF polymers used in the blend have molecular weights in the range of from 100,000 to 5,000,000 g/mol, and the acrylic polymers have molecular weights in the range of from 30,000 to 500,000. If the molecular weight of the acrylic polymer(s) is too high, the polymer will be too brittle for use in the membrane. When acrylic copolymers are used, having higher levels of alkyl acrylates, the Tg is lower and higher molecular weight can be tolerated.

The PVDF-acrylic emulsion formulations can be designed to be hydrophilic, fouling resistant, hydrophobic, or chemically cross linkable. Hydrophilic formulations will help improve water permeability and fouling resistance. Fouling resistance can be further improved using patented “dirt shedding” technology based on nano-particle additives. When incorporated into a membrane coating, these formulations may provide a convenient and unique way to boost membrane performance without resorting to expensive grafting technology.

The acrylic polymer may be a block copolymer structure, which can provide an improved morphological control in membrane formation—leading to controlled domain size, and a controlled micro-structure architecture. This leads to an improved porosity control and improved stability, as well as providing a better distribution of functional groups leading to excellent mechanical properties. The acrylic block copolymers can be made using known controlled radical polymerization techniques.

The PVDF and optional acrylic polymers are admixed together with a solvent to form a blended polymer solution. The PVDF and optional acrylic polymers may be blended together followed by dissolution, or the polymers may be separately dissolved in the same or different solvents, and the solvent solutions blended together. Solvents useful in dissolving the solutions of the invention include, but are not limited to N,N-dimethylacetamide, N,N-diethylacetamide, N-methyl-2-pyrrolidone, N-ethyl-2-pyrrolidone, acetone, dimethyl formamide, tetrahydrofuran, methyl ethyl ketone, tetramethyl urea, dimethyl sulfoxide, triethyl phosphate, N-octyl-pyrrolidone, gamma butyrolacetone, N,N′ dimethyl-trimethylene-urea, dimethylcarbonate, and mixtures thereof.

The polymer solution typically has a solids level of from 10 to 30 percent, preferably 15 to 22 and most preferably from 17 to 20 percent. The solution is formed by admixing and optionally heating at a temperature up to 80° C., and typically from 50 to 80° C.

In addition to the PVDF, optionally acrylic polymers and solvent, other additives may be added to the polymer solution, typically at from 1 to 20 weight percent and more preferably from 5 to 10 weight percent, based on the total solution. Typical additives include, but are not limited to, pore-formers which are typically hydrophilic water extractable compounds such as metallic salts (such as lithium, calcium and zinc salts), alcohols, glycols (such as polyethylene glycol, polypropylene glycol); silica, carbon nanotubes and other nano materials which may or may not be extracted; and compounds for increasing the viscosity of the solution for ease in processing of membrane materials. Other hydrophilic additives useful in forming the membranes include polyvinylpyrrolidone, poly-2-ethyloxazoline, polyvinylacetate, and polyvinyl alcohol”. Further, hollow sphere acrylic polymers can be added and are especially useful in a membrane distillation process, in which one side is hot and the other cold. The hollow spheres serving as an insulator for thermal heat transfer.

The solution viscosity can be adjusted to obtain the best processing condition. For flat sheet, the overall formulation is adjusted to obtain the best viscosity for a flat web casting. In hollow fiber formation, the process is actually a form of extrusion, and higher viscosities can be beneficial.

The solution comprising PVDF and optionally acrylic is then formed into membranes by typical processes known in the art, to form a flat sheet, supported flat sheet or hollow fiber membrane. In one typical process, said solution is solvent cast and drawn down onto a substrate. This membrane may be supported or unsupported, such as being cast onto a porous support web such as a woven or non-woven polyolefin or polyester. The membrane is then formed by a phase separation process, in which the thermodynamics of the cast membrane solution are disrupted, so that the polymer gels and phase separates from the solvent. The change in thermodynamics is often begun by a partial solvent evaporation, and/or exposure of the film to a high humidity environment. The membrane is then placed in a non-solvent for the polymer—such as water, an alcohol, or a mixture thereof—and the solvent removed, leaving a porous membrane. The pore size can be adjusted through the use of additives and the polymer concentration as known in the art. For example high molecular weight additives can lead to large pore sizes, while the use of lithium salt additives can produce small pore sizes.

The membranes of the invention are generally 75 to 200 μm, and preferably from 100 to 150 μm thick.

The membranes of the invention have an average pore sizes in the range of 0.1 to 10 μm as measured by ASTM F316.03 and ASTM E128.99 (2011).

Another object of the invention is a process for manufacturing said coated membrane, comprising the steps of:
i. providing a porous filtration membrane;
ii. providing a fluoropolymer-based emulsion;
iii. coating said membrane in said emulsion for a period sufficient to allow the membrane to become wet, followed by air drying of the wet membrane, and
iv. heat drying the membrane to remove residual water.

In one embodiment, the process further comprises a preliminary step of wetting the membrane in an organic solvent prior to step iii.

Step iv is preferably performed at a temperature comprised between 50 to 100° C.

Use of a fluoropolymer based emulsion coating can provide an excellent alternative to co-extrusion. MF TIPS membranes would be cast in a normal fashion. Then in a rather easy post treatment, the membranes will be soaked or coated with the emulsion solution, followed by drying. The latex top coating will help to seal up the larger pores and reduce the pore size range into the ultrafiltration range. This could be a break-through technology for these types of membranes.

The fluoropolymer coating composition of the invention can be applied to the membrane by techniques known in the art, such as, but not limited to, immersion, spray, coil coating, rolling, doctor blade, gravure coating.

The dry coating thickness is in the range of 0.1 to 4 microns, preferably from 0.5 to 3 microns, and most preferably from 0.5 to 1 micron.

One unique application for PVDF or fluoropolymer emulsion coatings on membranes is in the area of membrane distillation. Membrane distillation membranes require a hydrophobic surface that permits water vapor to penetrate the microporous membrane, while repelling bulk liquid water intrusion into the membrane. This technology is being studied as an alternative to high pressure reverse osmosis membranes. Use of fluoropolymer latex coatings for membranes can improve hydrophobicity for use in membrane distillation.

Another active area of membrane research is the use of thermally induced phase separation (TIPS) as a method to make stronger hollow fiber membranes. Hollow fiber membranes are typically preferred for water treatment applications due to their higher surface area per unit volume of membrane. Yet hollow fiber membranes are delicate and they can be prone to breakage in service. Improving mechanical strength is a major goal to improving hollow fiber membrane performance. One way to do this is to use the TIPS process, which makes inherently stronger membranes.

The disadvantage of TIPS membranes is that they are microfiltration membranes (larger pore size) and do not have the preferred rejection of ultrafiltration membranes. Therefore, they are more prone to irreversible fouling by blockage of the larger pores. A number of approaches have been used to convert MF TIPS membranes to UF TIPS membranes, but none has been very successful commercially. The major method being developed is a co-extrusion approach in which a TIPS membrane is cast and then a second “NIPS” membrane coating is applied over the top. This is a complicated, costly process, and delamination between the layers is a common problem.

Latex coatings can easily be applied and cured in place, unlike more aggressive conditions required for chemical grafting of coatings onto membranes using reactive monomers. Latex coatings on membranes can improve membrane performance in a number of ways, depending on the type of latex used. Specific benefits include: reducing surface defects by sealing up larger pores; reducing average pore size (this could be one way to take microfiltration TIPS membranes into the ultrafiltration range); adding anti-fouling character via hydrophilic groups contained in the latex polymer; adding hydrophobicity to improve use in membrane distillation; adding ionic charges to the surface by proper selection of charged monomers within the latex polymer. These benefits are not meant to be all inclusive, but rather to demonstrate the concept.

### EXAMPLES

The following examples illustrate the invention without limiting it.

### Test Methods:

Melt viscosity (MV): ASTM method D3835 (capillary rheometry). Measurements are reported at 232° C., 100 s⁻¹. Values are reported in kilopoise (kP).

Capillary Flow Porometry: ASTM F316-03 “Standard Test Methods for Pore Size Characteristics of Membrane Filters by Bubble point and Mean Pore Test”

Bubble point diameter: ASTM 316-03 and ASTM E128 99(2011) “Standard Test Method for Maximum Pore Diameter and Permeability of Rigid Porous Filters for Laboratory Use”

Pore diameter: ASTM F316 03 and ASTM E128 99(2011)

Gas permeability: ASTM F316 03

Tensile Strength: Instron 4201 universal testing machine, equipped with monofilament grips, grip spacing 125 mm, strain rate 100% min⁻¹.

Extensional viscometry: Experiments were conducted on a TA instruments ARES_LS strain rheometer installed with an extensional viscosity fixture (EVF). Transient extensional measurements were done at either 190° C. or 200° C. at a strain rate of 0.1 s⁻¹. Test specimens were prepared using a hydraulic press at 200° C. Extensional viscosity samples are 10 mm wide 18 mm long and 0.66 mm thick.

### Materials Used:

Fluoropolymer-acrylic latex: Kynar® ARC

Millipore Durapore® DVPP membrane (PVDF, hydrophilic)

Synder BX PVDF membrane (PVDF, supported membrane)

Pall Biotrace® membrane (PVDF, hydrophobic)

TIPS hollow fiber membrane (Kynar MG15)

TIPS hollow fiber membrane (Solef 1015).

The Millipore Durapore® membranes were the only ones directly wetted by aqueous solutions, including the ARC latex. The other membranes caused aqueous solutions, and the ARC latex, to bead up when treated. Therefore, the Durapore® membranes were directly treated with either full concentration latex or a 1:5 dilution of latex in water. The Durapore® membranes wetted out spontaneously when treated with either latex solution.

All the other PVDF membranes were treated with isopropyl alcohol first to fully wet out the membranes. These alcohol treated membranes were then immersed directly in the diluted ARC latex (1:5 in water) for 2 minutes, followed by air drying. The alcohol treated membranes appeared to wet out well with the latex solution. After air drying, the membranes were oven dried at 70° C. for 30 minutes to remove residual water.

Notably, the hollow fiber membranes felt much stiffer after the ARC treatment and drying than without it. The sheet membranes did not show much visual change after treatment, except for the Durapore® membrane treated with the full concentration ARC latex. This membrane appeared to have a thin, transparent coating layer present when viewed under an optical microscope.

The Durapore® membranes were tested by capillary flow porometry to compare pore size distribution. An untreated membrane was used as a control to compare with the ARC treatment.

TABLE 1

| | BPP | BPD | MPP | MPD | Gas flow @ |
|---|---|---|---|---|---|
| Membrane | (psi) | (um) | (psi) | (um) | 20 psi (lpm) |
| Durapore ® | 7.293 | 1.488 | 12.996 | 0.835 | 122 |
| Durapore ® + | 7.995 | 1.357 | 15.256 | 0.707 | 85 |
| dil. latex | | | | | |
| Durapore ® + | 10.772 | 1.007 | 46.256 | 0.235 | 5 |
| full latex | | | | | |

BPP = bubble point pore pressure
BPD = bubble point pore diameter
MPP = mean pore pressure
MPD = mean pore diameter
Reference capillary flow porometry ASTM
Um = micron
Psi = pounds per square inch
Lpm = liters per minute

Bubble point and capillary flow porometry test methods are described in ASTM F316 03(2011).

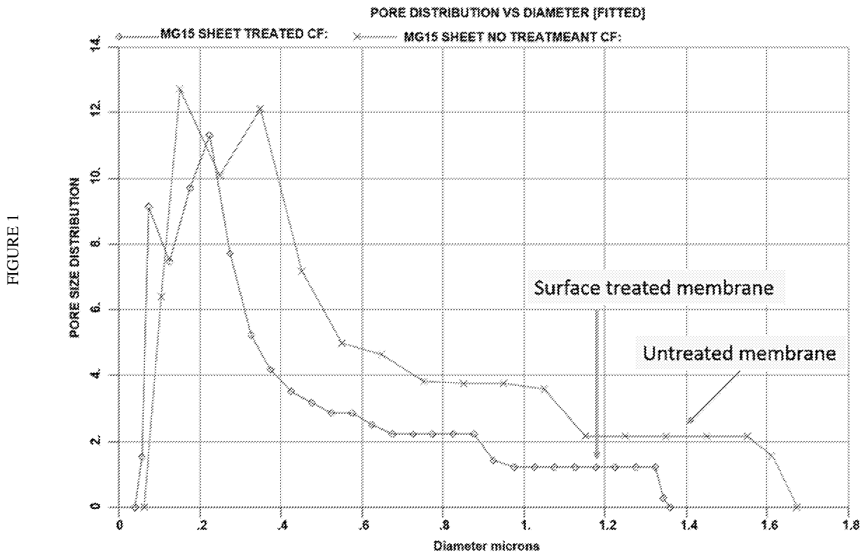

The graph of annexed FIG. 1 visually displays the pore size distributions between the different membranes. It is clear to see the effect of the latex coating reducing pore size distribution, confirming concept that this type of treatment can tailor membrane pore size closer to UF when starting from MF.

### Example 2

A membrane casting solution was prepared by mixing by weight Kynar MG15 (17%), polyvinylpyrrolidone K30 (7%), glycerol (6%), and dimethylacetamide (70%) in a glass vessel using an overhead mixer and heating to 80° C. for four hours. Formulation was left to sit in an oven overnight to degas at 60° C. The formulation was allowed to cool to room temperature before casting.

This formulation was cast onto Hollytex® 3265 non-woven fabric using a casting square with a 15 mil wet film gap. The cast membrane was then immersed in a pure methanol bath for 2 minutes at room temperature. The membrane was then transferred to a pure water bath held at room temperature for 3 minutes. The membrane was then transferred to another water bath and held for two hours. The water was changed out and the membrane left to soak overnight at room temperature. After overnight soaking, the membrane was immersed in a pure isopropanol bath for thirty minutes, followed by soaking in pure water bath for 30 minutes.

At this point, one membrane was removed for treatment with a latex coating. The latex formulation consisted of Aquatec® ARC (25%), water (25%), isopropanol (20%), and glycerol (30%. This formulation was coated onto the wet membrane at 2 mils using a draw down square. The coated membrane was left to air dry for two hours at ambient temperature and then dried for one hour in the oven at 60° C.

The second membrane was removed from the water bath and coated with a solution of glycerol (30%), water (50%), and isopropanol (20%) then allowed to air dry for 2 hours, followed by oven drying at 60° C. for one hour.

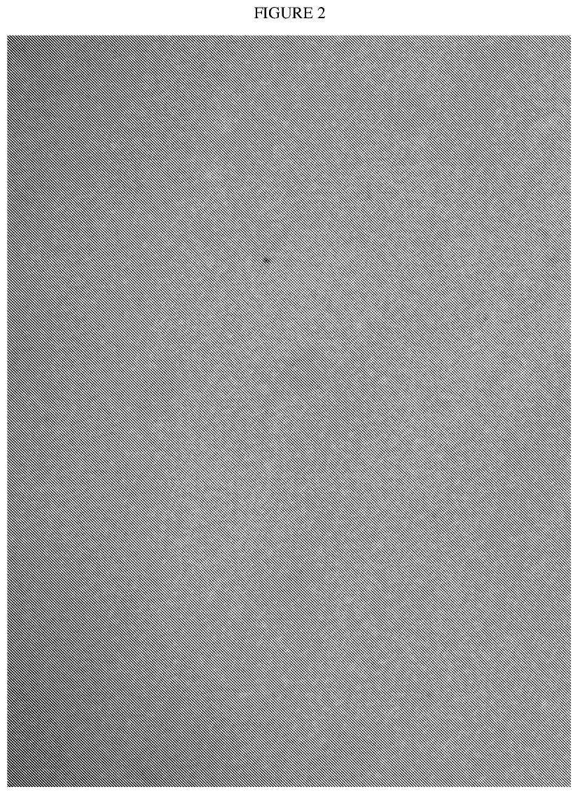

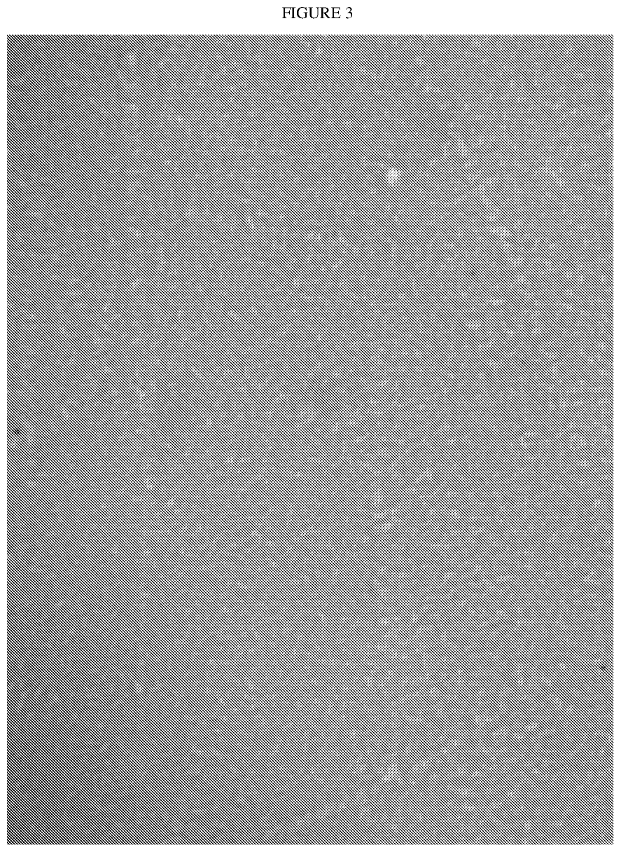

The dried membranes were examined under an optical microscope (Nikon SMZ800) at 60×. The resulting images are shown in FIGS. 2 and 3. The latex coated membrane (FIG. 2) had a clearly smoother surface with less open pore structure. The membrane not treated with latex (FIG. 3) had a rough surface structure, no skin layer, and some large surface pores.

Both membranes were tested by capillary flow porometry to compare pore size distribution. The pore size distribution of the latex treated membrane was narrower than the untreated membrane, as shown in FIG. 1. The bubble point diameter of the treated membrane was 1.361 um, compared to 1.673 um for the untreated membrane. The mean pore diameter was 0.294 um for the treated membrane, compared to 0.354 um for the untreated membrane.

1. A coated porous filtration membrane, wherein at least one surface of the membrane is coated with a fluoropolymer-based emulsion.

2. The coated porous filtration membrane of claim 1, wherein said fluoropolymer comprises a polyvinylidene homopolymer or copolymer comprising at least 70 weight percent of vinylidene fluoride monomer units.

3. The coated porous filtration membrane of claim 1, wherein said fluoropolymer-based emulsion comprises a blend of 1 to 40 weight percent of one or more acrylic polymers, and 60 to 99 weight percent of one of more fluoropolymers, based on the total weight of acrylic polymer and fluoropolymer.

4. The coated porous filtration membrane of claim 1, wherein said fluoropolymer-based emulsion comprises a blend of fluoropolymer latex and one or more acrylic latex.

5. The coated porous filtration membrane of claim 1, wherein said fluoropolymer-based emulsion comprises a fluoropolymer modified acrylic hybrid (AMF).

6. The coated porous filtration membrane of claim 1, wherein said fluoropolymer-based coating has a dry thickness of from 0.1 to 10 microns.

7. The coated porous filtration membrane of claim 1, wherein said membrane is a polymeric material chosen among: cellulose esters, polyimides, polyamides, polycarbonates, polysulfone, polyethersulfone, polyacrylonitrile, polyethylene, polypropylene, polyether ether ketone, polyether ketone, fluoropolymers and combinations thereof.

8. The coated porous filtration membrane of claim 1, wherein said membrane is made of polyvinylidene fluoride (PVDF) homopolymer or copolymers of vinylidene fluoride with one or more monomers selected from the group consisting of vinyl fluoride,
trifluoroethene, tetrafluoroethene, one or more of partly or fully fluorinated alpha-olefins, partly fluorinated olefins, perfluorinated vinyl ethers, fluorinated dioxoles, allylic, partly fluorinated allylic, and fluorinated allylic monomers.

9. A process for manufacturing the coated membrane of claim 1, comprising the steps of:
i. providing a porous filtration membrane;
ii. providing a fluoropolymer-based emulsion;
iii. coating said membrane in said emulsion for a period sufficient to allow the membrane to become wet, followed by air drying of the wet membrane, and
iv. heat drying the membrane to remove residual water.

10. The process of claim 9, further comprising a preliminary step of wetting the membrane in an organic solvent prior to step iii.

11. The process of claim 9, in which step iv is performed at a temperature comprised between 50 to 100° C.

12. (canceled)

13. The process of claim 9, wherein the fluoropolymer-based emulsion used for coating the membrane is hydrophobic.

14. (canceled)
